(19) United States
(12) Patent Application Publication
(10) Pub. No.: US 2009/0129908 A1
(43) Pub. Date: May 21, 2009

(54) Arm for Excavation Machine

(75) Inventors: Yasuyuki Oyamada, Fukuoka (JP); Keiichi Nishihara, Fukuoka (JP); Takahiro Ikeda, Fukuoka (JP); Takafumi Nobayashi, Fukuoka (JP); Masao Nagata, Fukuoka (JP); Saizou Kondou, Fukuoka (JP); Masami Miyanishi, Fukuoka (JP)

Correspondence Address: STERNE, KESSLER, GOLDSTEIN & FOX P.L.L.C., 1100 NEW YORK AVENUE, N.W., WASHINGTON, DC, 20005, US

(73) Assignee: Yanmar Co, Ltd., Osaka-shi, Osaka (JP)

(21) Appl. No.: 12/282,837

(22) PCT Filed: Aug. 25, 2006
(86) PCT No.: PCT/JP2006/316717

§ 371 Date: Oct. 3, 2008

(30) Foreign Application Priority Data
Mar. 13, 2006 (JP) 2006-067816

(51) Int. Cl. B66C 23/00

(52) U.S. Cl. 414/713

(57) ABSTRACT

An object of the present invention is to reduce manufacturing cost and manufacturing man-hour of an arm constituting a working machine in an excavation machine. In an arm 20 of a working machine 10 attached to an upper rotational body 30 supported on a center of an upper portion of a crawler-type traveling device 40 to be transversely rotatable, the arm 20 includes, as portions cast by integral molding, an arm support point part 21, a bucket support point part 24, and a bucket cylinder bottom support point part 22, and is configured so that the arm support point part 21 is connected to the bucket support point part 24 by a general-purpose rectangular pipe 28 and so that the bucket cylinder bottom support point part 22 is fixedly provided on an upper surface of the general-purpose rectangular pipe 28.

### FIELD OF THE INVENTION

The present invention relates to a technique for a structure of an arm constituting a working machine in an excavation machine typified by a power shovel or the like.

### BACKGROUND ART

A power shovel is an excavation machine well known as a hydraulic shovel excavation machine. The power shovel is basically structured to include a self-propelled lower traveling body and an upper rotational body rotatable by 360 degrees on the lower traveling body. The upper rotational body includes a boom and an arm, and an attachment such as a bucket is attached to the boom and the arm. Generally, in relation to the power shovel, the boom, the arm, and the bucket are generically referred to as “operating part” and the boom and the arm are generally referred to as “front”.

The arm is a cylindrical structure including three support point parts of an arm support point part, a bucket support point part, and a bucket cylinder bottom support point part. The arm acts as an “arm” connecting the boom to a bucket in the working machine. Furthermore, the arm includes a bucket cylinder actuating the bucket and arranged on an upper side of the arm.

To keep balance while the power shovel operates and to resist a load during an excavation operation, it is considered that the arm needs to have a strength and to be reduced in weight. Conventionally, an arm configured to bond left and right side plates to upper and lower plates by welding sand to have a rectangular cross section has been most popular. In such an arm, a cross-sectional area of a boom-side portion that needs a strength is made large. An arm having a triangular cross section and an arm having a generally trapezoidal cross section (for example, Patent Document 1) are also well known.

Patent Document 1: Japanese Unexamined Patent Publication No.

### DISCLOSURE OF THE INVENTION

### Problem to be Solved by the Invention

However, it takes considerably long operation time and labor to manufacture the side plates having a larger width on the boom-side portion and the like and to bond these side plates by welding. Consumption of component cost and manufacturing cost means consumption of manufacturing cost.

Problems to be solved are, therefore, to reduce manufacturing cost and manufacturing man-hour of an arm constituting a working machine in an excavation machine.

### Means Adapted to Solve the Problems

The problems to be solved by the present invention are those stated above. Means adapted to solve the problems will next be described.

Namely, the present invention is in an arm for a working machine attached to an upper rotational body supported on a center of an upper portion of a crawler-type traveling device to be transversely rotatable, wherein the arm includes, as portions cast by integral molding, an arm support point part, a bucket support point part, and a bucket cylinder bottom support point part, and is configured so that the arm support point part is connected to the bucket support point part via a slate part having constant transverse and longitudinal dimensions over an entire length and having a rectangular cross section, and so that the bucket cylinder bottom support point part is fixedly provided on an upper surface of the slate part.

Furthermore, according to the present invention, in the arm, the slate part is constituted by cutting a general-purpose rectangular pipe by an arbitrary length.

### EFFECT OF THE INVENTION

The present invention exhibits following advantages.

According to the present invention, in a configuration of the arm for the excavation machine, the slate portion other than the integrally molded cast portions, that is, a portion that can be made simple in shape can be produced only by cutting the general-purpose rectangular pipe by a necessary length. Namely, the number of components dedicated to the arm can be decreased.

According to the present invention, besides the above-stated advantages, a plurality of arms at lengths according to excavation machines on which the arms are mounted, respectively can be produced easily at low cost only by changing the length of the general-purpose rectangular pipe while using the arm support point part, the bucket support point part, and the bucket cylinder bottom support point part that are integrally molded cast portions as common components. Namely, versatility of the arm in the excavation machine can be improved. By adopting the general-purpose rectangular pipe and decreasing the number of components, manufacturing cost can be reduced. By adopting the general-purpose rectangular pipe, the number of welded portions is decreased and manufacturing man-hour can be, therefore, reduced.

### BRIEF DESCRIPTION OF THE DRAWINGS

FIG. 1 is a perspective view showing an overall configuration of a power shovel according to an embodiment of the present invention.

FIG. 2 is a perspective view showing a configuration of a working machine according to the embodiment of the present invention.

FIG. 3 is a perspective view showing a configuration of a boom and a cross-sectional view of slate parts according to the embodiment of the present invention.

FIG. 4 is a perspective view showing a configuration of an arm and a cross-sectional view of a slate part according to the embodiment of the present invention.

FIG. 5 is a perspective view showing a standard boom and a long front boom.

FIG. 6 is a perspective view showing a standard boom and a long front boom.

### REFERENCE NUMERALS

10 WORKING MACHINE
20 ARM
21 ARM SUPPORT POINT PART
22 BUCKET CYLINDER BOTTOM SUPPORT POINT PART
24 BUCKET SUPPORT POINT PART
28 GENERAL-PURPOSE RECTANGULAR TUBE
30 UPPER ROTATIONAL BODY
40 CRAWLER-TYPE TRAVELING DEVICE

### BEST MODES FOR CARRYING OUT THE INVENTION

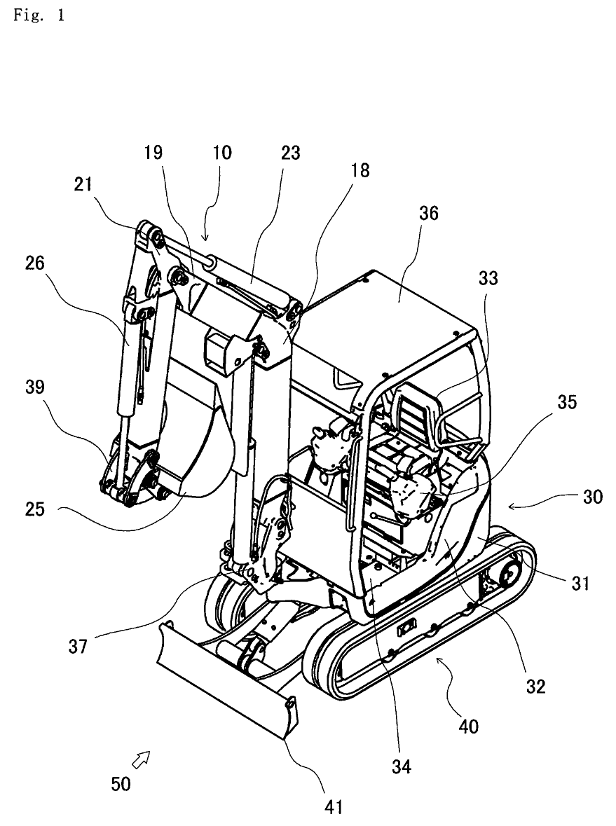

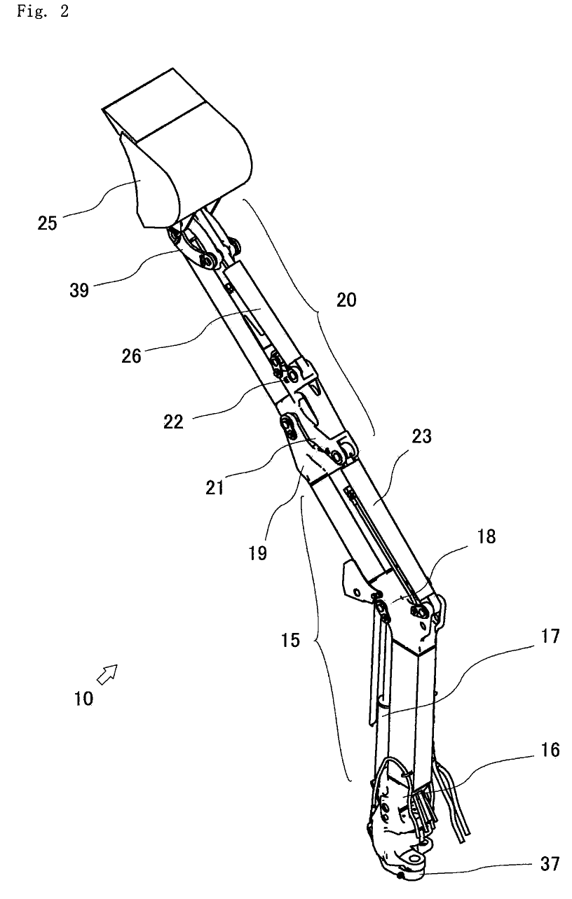

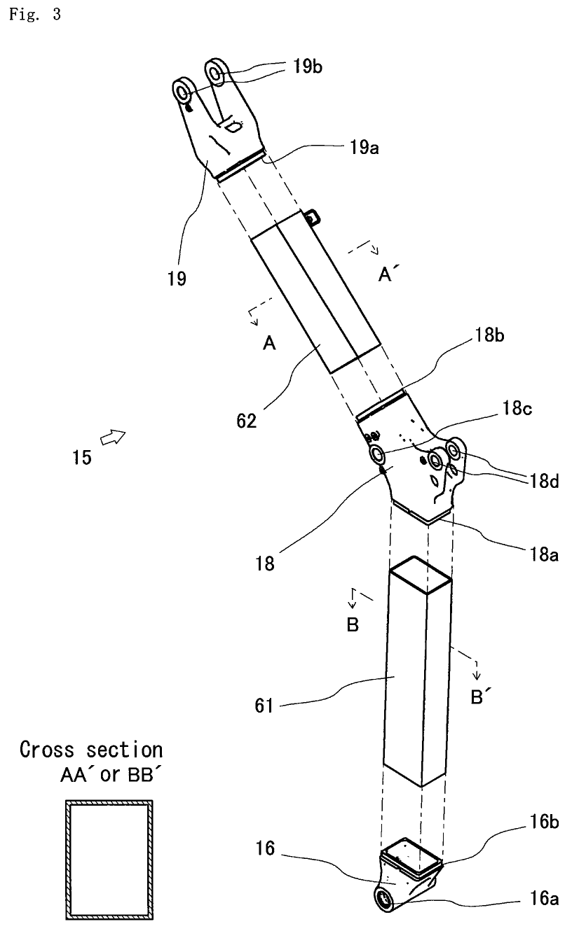

FIG. 1 is a perspective view showing an overall configuration of a power shovel according to an embodiment of the present invention. FIG. 2 is a perspective view showing a configuration of a working machine according to the embodiment of the present invention. FIG. 3 is a perspective view showing a configuration of a boom and a cross-sectional view of slate parts according to the embodiment of the present invention.

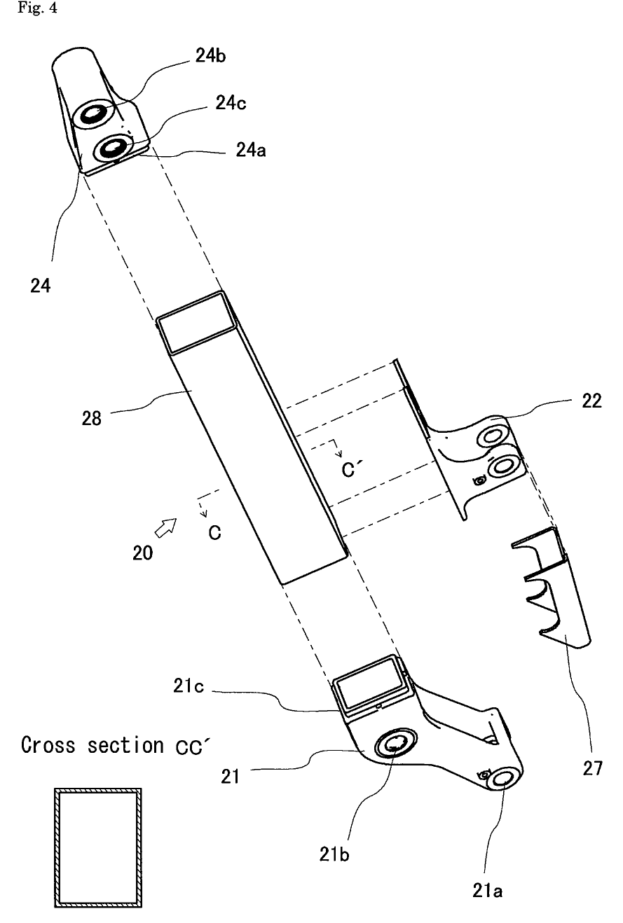

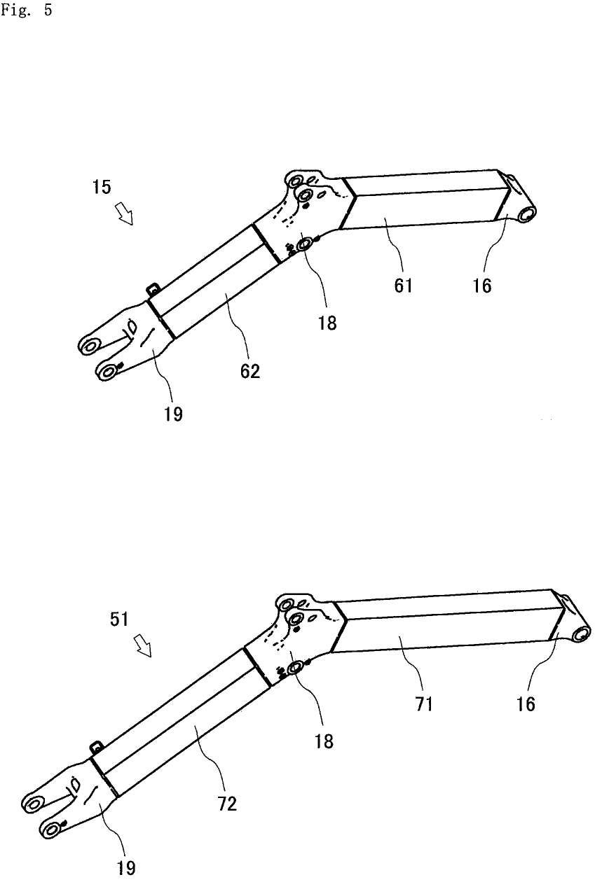

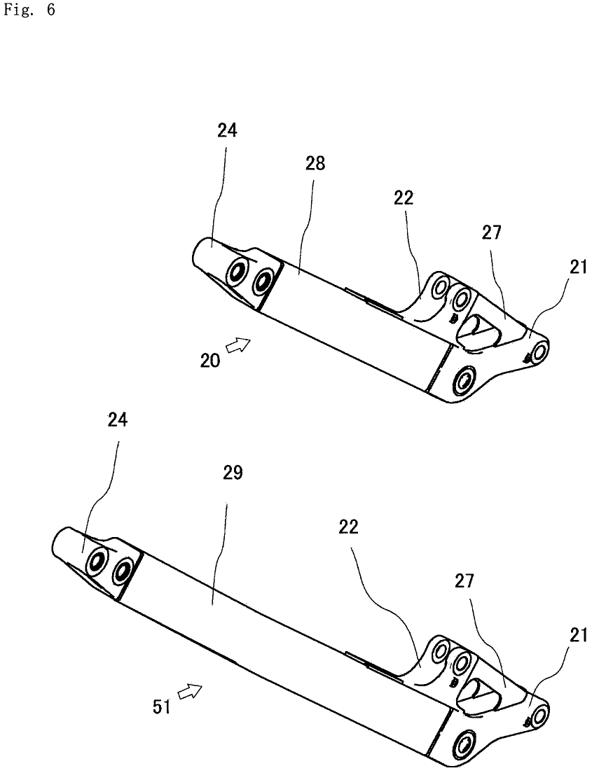

FIG. 4 is a perspective view showing a configuration of an arm and a cross-sectional view of a slate part according to the embodiment of the present invention. FIG. 5 is a perspective view showing a standard boom and a long front boom. FIG. 6 is a perspective view showing a standard boom and a long front boom.

As shown in FIG. 1, a power shovel 50 well known as an excavation machine is assumed as the embodiment of the present invention. A power shovel 50 is an excavation machine excavating earth and sand as an excavation machine. This power shovel 50 is a most popular hydraulic shovel excavation machine and can perform a loading operation mainly for an excavation operation for the earth and sand.

As shown in FIG. 1, the power shovel 50 is roughly configured to include a crawler-type traveling device 40, an upper rotational body 30 supported on a center of an upper portion of the crawler-type traveling device 40 to be transversely rotatable, and a working machine 10 attached to a transverse center of a front portion of the upper rotational body 30.

A blade 41 is vertically rotatably arranged on a longitudinal one side of the crawler-type traveling device 40. As the crawler-type traveling device 40, a variable gauge crawler can be used, and stability can be ensured by widening an interval of the crawler during an operation.

An engine (not shown) is mounted on a rear upper portion of a vehicle body frame 31 of the upper rotational body 30, a rear portion of the engine is covered with a bonnet, which is not shown, and the vehicle body frame 31, and both side portions thereof are covered with covers 32, respectively. A driver's seat 33 is arranged between the covers 32 and above the engine. An operation lever, a lock lever and the like are arranged near a front or side portion of the driver's seat 33 and a pedal and the like are arranged on a step 34 in front of the driver's seat 33, thereby constituting a driving operation part 35. Further, a canopy 36 is arranged above or a cabin is arranged around the driving operation part 35.

As shown in FIG. 2, the working machine 10 is roughly configured to include a boom 15, an arm 20, and a bucket 25.

A device driving the boom 15, the arm 20, and the bucket 25 will now be described. A boom bracket 37 is transversely rotatably attached to a transversely central portion on a front end of the vehicle body frame 31 (see FIG. 1), and transversely rotated by a swing cylinder (not shown). A boom support point part 16 provided in a lower portion of the boom 15 is vertically (longitudinally) rotatably supported in an upper portion of the boom bracket 37. Further, a boom cylinder 17 interposes between a front portion of the boom bracket 37 and a front portion of a boom cylinder rod support point part 18 halfway along the boom 15. Moreover, to rotate the arm 20, an arm cylinder 23 interposes between the boom cylinder rod support point part 18 halfway along the boom 15 and an arm support point part 21 provided on a rear end portion of the arm 20. Besides, to rotate the bucket 25, a bucket cylinder 26 interposes between a bucket cylinder bottom support point 22 in a rear portion of the arm 20 and the bucket 25.

In this way, in the working machine 10, the boom 15 can be rotated by driving the boom cylinder 17 to expand or contract, the arm 20 can be rotated by driving the arm cylinder 23 to expand or contract, and the bucket 25 can be rotated by driving the bucket cylinder 26 to expand or drive.

These cylinders 17, 23, and 26 serving as hydraulic actuators and a rotation motor rotating the upper rotational body are configured to be driven by supplying thereto a pressure oil from a hydraulic pump (not shown) through a hydraulic hose by changing over a control valve (not shown) by a rotation operation for rotating the operation level, the pedal or the like provided in the driving operation part 13 (see FIG. 1).

As shown in FIG. 3, the boom 15 is bent forward in a portion halfway along the boom 15 and formed in to a generally “dogleg” shape in a side view. It is to be noted that FIG. 3 shows that parts separate from one another so as to facilitate understanding a configuration of the boom 15.

The boom 15 is configured to include the boom support point part 16, the arm cylinder rod support point part 18, an arm support point part 19, a first slate part (first general-purpose rectangular tube) 61, a second slate part (second general-purpose rectangular tube) 62, and the like. A first slate part 61 is arranged between the boom support point part 16 and the arm cylinder rod support point part 18 and a second slate part 62 is arranged between the arm cylinder rod support point part 18 and the arm support point part 19. The first and second slate parts 61 and 62 are fixedly attached therebetween by welding, respectively. The boom support point part 16, the arm cylinder rod support point part 18, and the arm support point part 19 are cast components by integral molding. On the other hand, as each of the slate part 61 and 62, a metal general-purpose rectangular pipe transverse and longitudinal lengths of which are set to predetermined lengths (normalized) is used. In the present embodiment, identical general-purpose rectangular pipes are used as the first slate part 61 and the second slate part 62. Namely, as shown in FIG. 3, an AA′ cross-sectional shape of the first slate part 61 is identical to a BB′ cross-sectional shape of the second slate part 62 while the first slate part 61 and the second slate part 62 differ only in length. The boom 15 can be reduced in weight to some extent by configuring the cross-sectional shape of the second slate part 61 to be smaller than that of the first slate part 61.

A shaft hole 16a is opened transversely on a proximal portion side of the boom support point part 16 and the boom support point part 16 is pivotally supported in the upper portion of the boom bracket 37 by a pivoted spindle. The other end side (upper portion) of the boom support point part 16 is opened to have a rectangular shape to conform to the cross-sectional shape of the first slate part 61. An edge portion is formed on an outer circumference of this opening portion 16b so as to be able to fit one end of the first slate part 61 into the edge portion.

The arm cylinder rod support point part 18 is formed out of a rectangular pipe-shaped component having a portion halfway along the rectangular pipe-shaped component formed into a generally “dogleg” shape in a side view. The arm cylinder rod support point part 18 is configured so that an opening portion 18a on one end (in a lower portion) of the arm cylinder rod support point part 18 is formed into a rectangular shape to conform to the cross-sectional shape of the first slate part 61, and so that an edge portion is formed on an outer circumference of this opening portion 18a so as to be able to fit the other end of the first slate part 61 into the edge portion. An opening portion 18b on the other end (in an upper portion) of the arm cylinder rod support point part 18 is formed into a rectangular shape to conform to the cross-sectional shape of the second slate part 62. An edge portion is formed on an outer circumference of this opening portion 18b so as to be able to fit one end of the second slate part 62 into the edge portion. A shaft hole 18c is opened transversely in a portion vertically halfway along a front surface of the arm cylinder rod support point part 18, and configured so that a pivoted spindle can pivotally support a tip end of a piston rod of the boom cylinder 17. Supporting convex portions 18d are formed in a portion vertically halfway along a rear surface side of the arm cylinder rod support point part 18, and shaft holes are opened transversely in the respective supporting convex portions 18d so that a pivoted spindle can support a bottom side of the arm cylinder 23.

The arm support point part 19 is configured so that a rectangular opening portion 19a conforming to the cross-sectional shape of the second slate part 62 is formed on a proximal portion side of the arm support point part 19, and so that an edge portion is formed on an outer circumference of this opening portion 19a so as to fit the other end (upper portion) of the second slate part 62 into the edge portion. Forked protruding portions 19b are formed on the other end (tip end) of the arm support point part 19, and shaft holes are transversely formed in the protruding portions 19b, respectively to enable a pivoted spindle to pivotally support a proximal portion side of the arm 20. By forming the outer circumference of the opening side of the support point part identical in shape to that of the slate part, the support point part can be connected to the slate part without differences in height, thereby making it possible to improve external appearance.

To keep balance while the excavation machine operates and to resist load during an excavation operation, it is considered that the boom needs to have a strength and to be reduced in weight. Conventionally, the boom configured to bond left and right side plates to upper and lower plates by welding and to have the rectangular cross section has been most popular.

As described in the present embodiment, the same general-purpose pipes are used for the slate parts 61 and 62, thereby making it possible to decrease the number of components (types of components) of the boom 15. Furthermore, the general-purpose rectangular pipes are generally inexpensive. Namely, component cost of the boom 15 can be reduced by decreasing the number of components and adopting the general-purpose rectangular pipes. Besides, it suffices to cut each of the general-purpose rectangular pipe only by a necessary length for working without a welding operation for forming the cross section as that according to the conventional technique, thereby making it possible to reduce manufacturing man-hour. In this way, manufacturing cost can be reduced by reducing the component cost and the manufacturing man-hour.

Similarly to the conventional technique, even if the general-purpose rectangular pipes are used for the respective slate parts 61 and 62, the boom 15 can be formed into a “dogleg” shape by adjusting angles of connected surfaces of upper and lower ends of the arm cylinder rod support part 18. Furthermore, as for a central portion the necessary strength of which has been conventionally kept by making the cross-sectional area large, a necessary strength can be attained by making a cross-sectional area of the arm cylinder rod support point part 18 that is a cast component large.

As shown in FIG. 4, the arm 20 is roughly configured to provide support parts in front and rear of a slate part 28, respectively. It is to be noted that FIG. 4 shows that parts separate from one another so as to facilitate understanding a configuration of the arm 20.

The arm 20 is configured to include the slate part 28, an arm support point part 21 and a bucket support point part 24 arranged on both sides of the slate part 28 and fixedly provided thereto by welding or the like, respectively, a bucket cylinder button support point part 22 provided on the slate part 28, an arm reinforcement 27 connecting the arm support point part 21 to the bucket cylinder bottom support point part 22, and the like. The arm support point part 21, the bucket cylinder bottom support point part 22, and the bucket support point part 24 are cast components by integral molding. A general-purpose rectangular pipe is used as the slate part 28. FIG. 4 shows a cross-sectional view of a CC′ cross section of the slate part 28. Further, the arm reinforcement 27 is produced by conducting a bending work or the like on a sheet plate.

The arm support point part 21 is configured so that a shaft hole 21a is opened transversely on a proximal portion side of the arm support point part 21 to enable a pivoted spindle to pivotally support a tip end of a piston rod of the arm cylinder 23, and so that a shaft hole 21b is opened transversely in a portion halfway along the arm support point part 21 to enable a pivoted spindle to pivotally support the arm support point part 21 in an upper portion of the boom 15. The other end (tip end portion) of the arm support point part 21 is opened into a rectangular shape to conform to a cross-sectional shape of the slate part 28. An edge portion is formed on an outer circumference of this opening portion 21c so as to be able to fit one end of the slate part 28 into the edge portion.

The bucket support point part 24 is configured so that a rectangular opening portion 24a to conform to the cross-sectional shape of the slate part 28 is formed on a proximal portion side of the bucket support point part 24, and so that an edge portion is formed on an outer circumference of this opening portion 24a so as to be able to fit the other end (tip end) of the slate part 28 in the edge portion. The bucket support point part 24 is configured so that a shaft hole 24b is opened transversely on the other end (tip end) of the bucket support point part 24 to enable a pivoted spindle to pivotally support a proximal portion side of the bucket 25, and so that a shaft hole 24c is opened transversely in a portion halfway along the bucket support point part 24 so as to be able to pivotally support one end of a connection link 39 connected to a tip end of a piston rod of the bucket cylinder 26. By forming an outer circumference of the opening side of the support point part identical in shape to that of the slate part, the support point part can be connected to the slate part without differences in height, thereby making it possible to improve an external appearance.

The bucket cylinder bottom support point part 22 is configured into an inverted U shape in a front view and configured to be fixedly provided on an upper surface of a rear portion of the slate part 28 by welding or the like. The bucket cylinder bottom support point part 22 is also configured so that a shaft hole is opened in an opening-side upper portion of the bucket cylinder bottom support point part 22 to enable a pivoted spindle to pivotally support a proximal portion side of the bucket cylinder 26. Furthermore, an upper portion of the bucket cylinder bottom support point part 22 is fixedly connected to an upper portion of the arm support point part 21 by the arm reinforcement 27 by welding or the like.

To keep balance while the excavation machine operates and to resist load during the excavation operation, it is considered that the arm needs to have a strength and to be reduced in weight. Conventionally, the arm configured to bond left and right side plates to upper and lower plates by welding and to have the rectangular cross section has been most popular.

As described in the present embodiment, the general-purpose pipe is used for the slate part 28, thereby making it possible to decrease the number of components of the arm 20. Furthermore, the general-purpose rectangular pipe is generally inexpensive. Namely, component cost of the arm 20 can be reduced by decreasing the number of components and adopting the general-purpose rectangular pipe. Besides, it suffices to cut the general-purpose rectangular pipe only by a necessary length for working without a welding operation for forming the cross section as that according to the conventional technique, thereby making it possible to reduce manufacturing man-hour. In this way, manufacturing cost can be reduced by reducing the component cost and the manufacturing man-hour.

As for a boom-side portion the necessary strength of which has been conventionally kept by making a cross-sectional area of the boom-side large, a necessary strength can be attained by the arm support point part 21 and the bucket cylinder bottom support point part 22 that are cast components as well as the arm reinforcement 27.

The same general-purpose rectangular pipe as those used for the first slate part 61 and the second slate part 62 of the boom 15 can be used for the slate part 28 of the arm 20. In this way, by producing the slate parts 28, 61, and 62 of the working machine 10 by cutting each of the same general-purpose rectangular pipes only by the necessary length, the manufacturing cost can be further reduced.

As shown in FIG. 5, a boom 51 (long boom) larger in entire length than the above-stated boom 15 (standard boom) is often provided in the power shovel 50. Since the boom and the arm are referred to as “front”, an excavation machine including such a longer boom or arm than the standard boom or arm is generally referred to as “long front or high lift front”. The long front is adopted to widen an operating radius or to conduct excavation at a deeper position whereas the high lift front is adopted to reach a higher position than usual.

In the present embodiment, the long boom 51 can be configured by slate parts 71 and 72 obtained by increasing lengths of the slate parts 61 and 62 of the standard boom 15, respectively, and the boom support point part 16, the arm cylinder rod support point part 18, and the arm support point part 19 similar to those of the standard boom 15.

Only by changing the lengths of the general-purpose rectangular pipes as stated above, a plurality of booms at lengths according to excavation machines on which the booms are mounted, respectively can be produced. Namely, it is possible to improve versatility of the boom for excavation machines of the same type and reduce the manufacturing cost entirely for the type of the machines.

However, if the first slate part 61 is extended, it is necessary to provide the support part supporting the tip end of the piston rod of the boom cylinder on an upper front surface of the first slate part 61 so as to use the same boom cylinder. It is also necessary to provide the bottom-side support part thereof in a rear upper portion of the second slate part 62 so as to use the same arm cylinder.

As stated so far, the boom in which the same boom support point part 16, the same arm cylinder rod support point part 18, and the same arm support point part 19 are used, in which the longitudinal length of any one of or each of the first slate part 61 and the second slate part 62 is changed, and which has the different entire length is attached to the boom bracket 37 and is configured to be operable. Therefore, only by changing the length of each of the general-purpose rectangular pipes, a plurality of booms at lengths according to excavation machines on which the booms are mounted, respectively can be produced. Namely, the versatility of the boom in the excavation machines of the same type can be improved.

As shown in FIG. 6, an arm 52 (long arm) larger in entire length than the above-stated arm 20 (standard arm) is often provided in the power shovel 50.

In the present embodiment, the long arm 52 can be configured by a slate part 29 obtained by increasing the entire length of the slate part 28 of the standard arm 20 as well as the arm support point part 21, the bucket cylinder bottom support point 22, and the bucket support point similar to those of the standard arm 20. It is preferable to change the length of the arm reinforcement 27 if it is necessary to do so.

In this way, only by changing the length of each of the general-purpose rectangular pipes, a plurality of booms at lengths according to excavation machines on which the booms are mounted, respectively can be produced. Namely, the versatility of the boom in the excavation machines of the same type can be improved and manufacturing cost of the overall excavation machines of the type can be reduced.

In the present embodiment, the manufacturing cost can be reduced by using the general-purpose rectangular pipes for the slate parts 28, 61, and 62 of the boom 15 or the arm 20 in the power shovel 50, respectively. The present invention is not limited to the power shovel 50 but can be applied to other excavation machines each including the boom or arm.

### INDUSTRIAL APPLICABILITY

An example of using the present invention includes an excavation machine.

1. An arm for a working machine attached to an upper rotational body supported on a center of an upper portion of a crawler-type traveling device to be transversely rotatable,
wherein the arm includes, as portions cast by integral molding, an arm support point part, a bucket support point part, and a bucket cylinder bottom support point part, and is configured so that the arm support point part is connected to the bucket support point part via a slate part having constant transverse and longitudinal dimensions over an entire length and having a rectangular cross section, and so that the bucket cylinder bottom support point part is fixedly provided on an upper surface of the slate part.

2. The arm according to claim 1,
wherein the slate part is constituted by cutting a general-purpose rectangular pipe by an arbitrary length.
